(19) United States
(12) Patent Application Publication
(10) Pub. No.: US 2010/0304076 A1
(43) Pub. Date: Dec. 2, 2010

(54) Elongated floor rug for bathroom toilets

(76) Inventor: Paul Franklin Adan, Tacoma, WA (US)

Correspondence Address: Paul F. Adan, 15803 42nd Ave. E., Tacoma, WA, 98446, US

(21) Appl. No.: 12/454,849

(22) Filed: May 26, 2009

(51) Int. Cl. B32B 33/00

(52) U.S. Cl. 428/85

(57) ABSTRACT

An elongated floor rug (24), suitable for use in a bathroom, having a slot opening (14) on one end adapted to receive and partially surround a toilet base (6) of a toilet (4) having an attached water compartment (20). The slot opening comprises a flap (12a) and a flap (12b) on each side of the rug, and an innermost edge (16) of the rug on a third side. The rug comprises a multitude of rug strand (10). When the rug is properly positioned on a floor (18), as indicated in FIG. 1, the slot opening resides below a toilet bowl (8) of the toilet. The portion of the rug which is proximate to the toilet functions as a toilet rug, and thereby serves the needs of a toilet-user. The rug is sufficiently long to also function as a bath rug, thereby meeting the needs of a wet bather.

### BACKGROUND

1. Field of Invention

This invention relates to bathroom rugs, specifically to an elongated floor rug for bathroom toilets.

2. Description of Prior Art

Rugs have been around for millennia. In the 1800s, when indoor plumbing was invented, savvy bathers no doubt used rugs to provide a soft, comparatively warm, slip-free surface to stand on while drying off. Over the intervening years, rug manufacturers have produced millions of rugs of varying shapes and sizes that are meant to be used in bathrooms. Some of these are rectangular, either with rounded or square corners, and others are oval. Usually, these water-absorbent rugs are cut to such dimensions that they can be placed on the floor in front of vanities, vanities with sinks, tub and shower inserts, and free-standing bathtubs or Jacuzzis.

Because there are so many variations, and because these “non-specific” rugs have been around so long anyway, there are relatively few patents pertaining to bathroom rugs. Those patents that have been issued are generally in the Design category—for example, U.S. Pat. D414,973 (Charles W. Craft and Nicole France, Oct. 12, 1999), and D428,293 (Mattique J. Williams, Jul. 18, 2000). There also appears to be no clearly established functional difference between a “mat” and a “rug” in many of the patents that have been issued.

The idea of placing a floor mat around the base of a bathroom toilet originated in January, 1940. During this month, U.S. Pat. No. 2,187,676 was issued to John W. Biewen. This patent describes an absorbent mat that would prevent the floor around the toilet from becoming wet and unsanitary. Except for the mat's ability to reduce or eliminate obnoxious odors, the comfort of a toilet-user was not even a consideration. Aesthetics also appears to have been secondary in importance. For reference purposes, see also U.S. Pat. No. 2,771,613 (Anna V. Markiewicz, Nov. 27, 1956).

Subsequent patents issued after U.S. Pat. No. 2,187,676 have largely been ornamental design variations of Mr. Biewen's “Absorbent Floor Mat”—for example, U.S. Pat. Des.402,841 (Rosa L. Dobbs, Dec. 22, 1998), Des.409,427 (Carol A. Ford and Glenn M. Ford, May 11, 1999), Des.414,252 (Judy J. Orr, Sep. 21, 1999), D498,964 (Al Spencer, Nov. 30, 2004), and D543,063 S (Charlotte Y. Brown, May 22, 2007). These patents either provided novel ways of securing a mat or rug to the toilet, or introduced toilet mats or rugs with new shapes. In spite of their novelty, however, the toilet rugs most frequently manufactured today are those that are similar in appearance to Mr. Biewen's mat.

The problem with all of these mats and rugs is that they do not fully address the dimension requirements of small bathrooms. The nature of this problem is compounded by the following realities:
(a) Most “newer” houses available on the market today, were built with two or more bathrooms—the larger of which is called the “master bathroom” or “master bath.” The secondary bathroom, called the “second bathroom” or the “guest bathroom,” is smaller than the master. Usually, these second bathrooms are built to accommodate a bathing-unit insert comprising a bathtub, or a shower, or a combination thereof.
(b) Many “older” houses on the market were built decades ago when houses were smaller—and hence bathrooms were smaller. Even when these bathrooms are remodeled in order to upgrade a house to current standards, the “new” bathroom frequently includes a bathing-unit insert which, again, dictates the size of the bathroom.
(c) For the sake of saving space and money, most rental units in apartment buildings are constructed with bathrooms that are comparable in size to the second bathrooms, described in (a), above. Again, bathing-unit inserts are commonly used in these bathrooms.
(d) The length dimension of bathing-unit inserts demands that a bathroom be constructed to have approximately the same width as the length of the insert. Frequently, this constraint also demands that the toilet be placed adjacent to the bathing-unit insert. When this is the case, the width of the bathroom will not accommodate both a toilet rug and a bath rug.
(e) The toilet rugs currently available on the market are not sufficiently long to serve both as a toilet rug, and as a bath rug.
(f) The “non-specific” bathroom rugs currently available on the market that can serve as bath rugs are not appropriately shaped to also surround the contours of a toilet.

### OBJECTS AND ADVANTAGES

Accordingly, several objects and advantages of my invention are:
(a) to provide a rug which will better suit the dimensional requirements of small bathrooms, specifically those bathrooms which include bathing-unit inserts;
(b) to provide a rug which is sufficiently long and appropriately shaped to function as both a toilet rug, and as a bath rug;
(c) to provide a rug which will reduce bathroom clutter, and thereby enhance the aesthetic appearance of the bathroom; and
(d) to provide a rug which will combine the features of both a toilet rug and a bath rug into a single rug, thereby reducing manufacturing costs.

Further objects and advantages are to provide home-owners and apartment residents a single water-absorbent rug that functions both as a toilet rug and as a bath rug, which thereby negates the need to purchase two separate rugs. Additional objects and advantages will become apparent by examining the ensuing description and drawings.

### DRAWING FIGURES

FIG. 1 is a perspective view of my elongated floor rug applied, thereto.

FIG. 2 is a plan view of my invention, detached.

FIG. 3 is a perspective view of a standard toilet rug applied, thereto.

Reference Numerals in Drawings

| | | | |
|---|---|---|---|
| 4 | toilet | 6 | toilet base |
| 8 | toilet bowl | 10 | rug strand |
| 12a | flap | 12b | flap |
| 14 | slot opening | 16 | innermost edge |
| 18 | floor | 20 | water compartment |
| 22 | bathing-unit insert | 24 | elongated floor rug |
| 26 | standard toilet rug | | |

Similar reference numerals in each of the views of my invention indicate corresponding parts.

### SUMMARY

My invention comprises an elongated floor rug, suitable for use in a bathroom, which contains a slot opening on one end that allows the rug to fit around a toilet base. The rug is sufficiently long to allow it to also function as a bath rug.

### Description—FIGS. 1 to 3

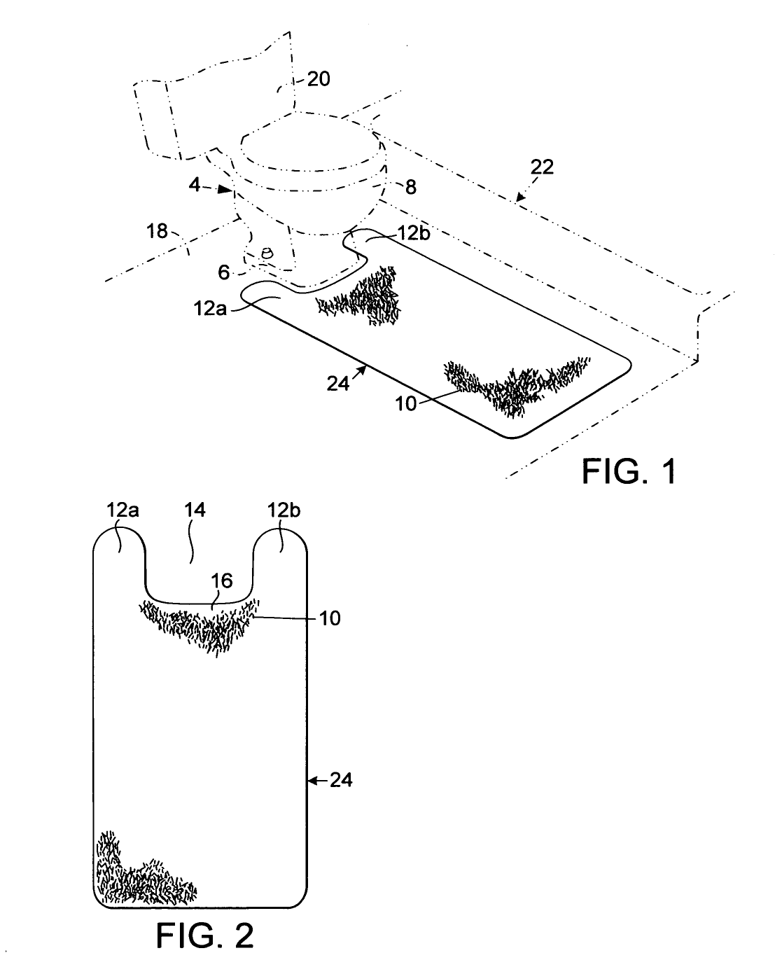

Referring to FIG. 1 of the drawings, an elongated floor rug 24 is shown applied to a toilet 4 of standard construction. The toilet has a usual toilet base 6, a toilet bowl 8, and a water compartment 20, as shown. Adjacent to the toilet is a bathing-unit insert 22. Phantom lines that are visible inside the confines of a flap 12b of the rug are not part of the rug and are shown for illustrative purposes only. A rug strand 10, also shown in FIG. 2, is made of flexible water-absorbent fabric suitable for making a bathroom rug. The rug strand is understood to repeat uniformly throughout the entire rug.

The elongated floor rug is generally rectangular in shape, and is made of a multitude of rug strand. On the end of the rug that resides next to the toilet are a flap 12a, and the flap 12b. Flap 12a is positioned to the left of the toilet base when the rug is applied to the toilet, as shown in FIG. 1. Similarly, flap 12b is positioned to the right of the toilet base when the rug is applied. A slot opening 14, shown in FIG. 2, is the area enclosed on three sides by the flaps, 12a and 12b, and an innermost edge 16 of the rug. The slot opening is the location where the toilet base resides when the rug is applied to the toilet. Stated differently, the rug is positioned on a floor 18 beneath the toilet bowl, and is adapted to partially surround the contours of the toilet base, as shown in FIG. 1. The distal portion of the rug from the toilet is more linearly shaped, except for the corners which are rounded. In this respect, this distal portion of the rug resembles a standard bath rug. The overall length of the rug is such that the distal portion extends well beyond the overhang of the toilet bowl.

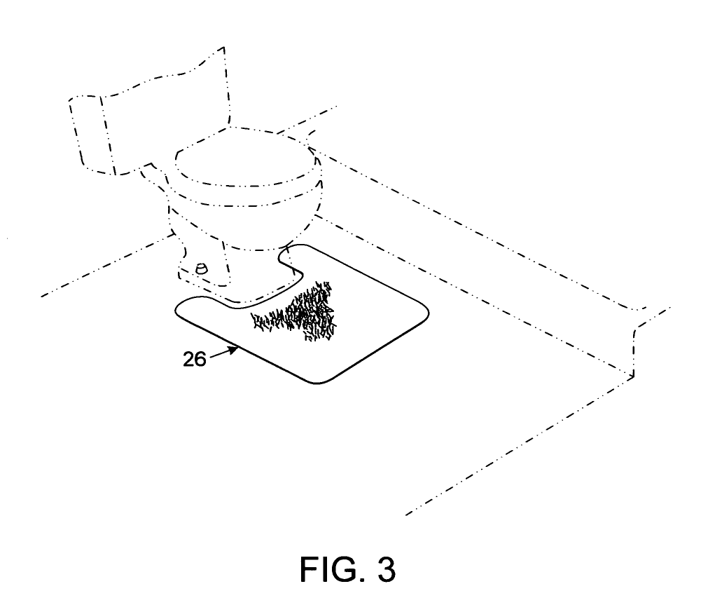

FIG. 3 shows a standard toilet rug 26 presently used by individuals in the population at-large, and available for purchase in the marketplace. The rug shown in this figure embodies all the features of the elongated toilet rug of this invention, with one crucial exception. Specifically, the rug of FIG. 3 is not elongated, as is the rug that is shown in FIGS. 1 and 2.

The positional references, “left” and “right,” used to describe the flaps in FIG. 1 are based on the perspective of a toilet-user who is facing towards the toilet.

### Operation—FIGS. 1 and 2

The manner of using the elongated floor rug, as indicated in FIG. 1, is to place the slotted end of the rug around toilet base 6 of toilet 4. When positioned below the overhang of toilet bowl 8, in this manner, the portion of the rug that resides by the toilet functions in an identical manner to that of toilet rugs in present use. Namely, flap 12a and flap 12b, each on opposite sides of the toilet from the other, serve to protect floor 18 from becoming wet or stained when the toilet is in use, while at the same time providing a soft, comparatively warm, slip-free area for a toilet-user's feet. Innermost edge 16 of the rug which resides below the overhang of the toilet bowl, and the portion of the rug immediately in front of the toilet, serves the same functions.

Another aspect of the elongated floor rug, when the rug is properly placed as in FIG. 1, is that the distal portion of the rug from the toilet serves as a bath mat. In this respect, the function of the distal portion of the rug is identical to bath rugs in present use. The purpose of bath rugs, like toilet rugs, is to provide a soft, comparatively warm, slip-free area for one's feet. The functional difference between a bath rug and a toilet rug, however, is that a bath rug is not intended to be used next to a toilet, or to serve the needs of a toilet-user. Rather, a bath rug's purpose is to serve the needs of a wet bather who needs a place to stand on while drying off. A further purpose of a bath rug is to absorb any water that drips off of the wet bather, thus preventing puddles from forming on the bathroom floor.

### CONCLUSION, RAMIFICATIONS, AND SCOPE OF THE INVENTION

The elongated floor rug, thereby, embodies the features of both a toilet rug and a bath rug. In other words, when applied to a toilet as in FIG. 1, the portion of the rug which is proximate to the toilet functions as a toilet rug. Meanwhile, the portion of the same rug which is distal to the toilet functions as a bath rug. This dual functionality is possible because the elongated floor rug is sufficiently longer than toilet rugs in present use. In essence, the elongated floor rug combines the positive features of a toilet rug and a bath rug, and incorporates those features into a single rug.

The elongated floor rug shown herein, in both FIG. 1 and FIG. 2, can be adapted to fit toilets of various sizes without departing from the scope of the invention. The rug can also be constructed of any suitable material, and be made in different sizes, shapes, and colors without departing from the spirit of the invention. Based on these understandings, the scope of this invention should be determined by the appended claims and their legal equivalents, rather than by the preferred example shown in FIGS. 1 and 2.

1. A rug for use with a toilet with a toilet base and a bathing unit insert, such as a tub or shower, alongside the toilet, the rug comprising a slot opening on a first end adapted to at least partially receive therein the toilet base, and wherein, when the rug is implemented alongside the bathing unit insert and at least partially receives the toilet base in the slot, the rug is of length such that it extends approximately from intermediate the toilet bowl to the end or near the end of the bathing insert and is thus sufficiently long for one to stand on said rug while drying off.

2. (canceled)

3. (canceled)

4. (canceled)

5. (canceled)

6. (canceled)

7. (canceled)

8. (canceled)

9. (canceled)

10. (canceled)
